(19) United States
(12) Patent Application Publication
(10) Pub. No.: US 2005/0012322 A1
(43) Pub. Date: Jan. 20, 2005

(54) Pads with withdrawable leaves

(76) Inventor: David Austin Clilvered, Buckinghamshire (GB)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/488,362

(22) PCT Filed: Sep. 2, 2002
(86) PCT No.: PCT/GB02/03988

(30) Foreign Application Priority Data
Sep. 3, 2001 (GB) 0121334.7

(51) Int. Cl. B42D 17/00

(52) U.S. Cl. 281/44

(57) ABSTRACT

A notepad is made up of paper leaves (1) that carry pressure-sensitive adhesive (7) and fan out from one another about a common axis (2). The leaves (1) are held together along the axis allowing them to be individually withdrawn from the pad, and stiffer leaves (8,9) of card are distributed through the pad intermediate the paper leaves (1) for supporting the pad following paper-leaf withdrawal. The pad is erected from a paper and card stack that has a bendable binding (6) along one edge for enabling the top and bottom leaves (9) of the stack to be brought round into face to face contact and bonded together. The leaves (6,8,9) are all of the same shape, for example, outlining and printed to depict half a tree, a fruit or a person's face, to configure the erected pad as a spheroid or other solid of revolution. The pad can be used for ‘greetings’ or calendar purposes as an alternative or in addition to its use for notes.

This invention relates to pads with withdrawable leaves.

According to one aspect of the present invention there is provided a pad wherein a plurality of leaves are assembled together face to face with one another and with a plurality of intermediate leaves stiffer than the first-mentioned leaves in a configuration in which said first-mentioned leaves and the intermediate leaves fan out from one another substantially radially from a common axis, said first-mentioned leaves being individually releasable from the pad by withdrawal from between their adjacent leaves, and wherein the intermediate leaves are distributed through the pad for maintaining support for it in said configuration following withdrawal of first-mentioned leaves as aforesaid.

The configuration of the pad may be substantially that of a spheroid, or other solid of revolution about said axis, with said first-mentioned leaves all of the same shape as, and in register with, one another. Furthermore, said first-mentioned leaves may be releasably attached to one another by strips of pressure-sensitive adhesive that enable them to be attached elsewhere when withdrawn from the pad.

The pad may be erected from a stack of leaves, and in this respect and according to another aspect of the present invention there is provided a pad which comprises a plurality of leaves assembled together face to face with one another into a stack that includes top, bottom and intermediate leaves that are stiffer than the first-mentioned leaves, the stack having a bendable binding along one of its edges to enable the top and bottom leaves to be brought round face to face with one another into a configuration of the stack in which said first-mentioned leaves fan out from one another substantially radially from a common axis and are individually releasable from the pad by withdrawal from between their adjacent leaves, and wherein there are a plurality of said intermediate leaves distributed through the pad for maintaining support for it in said configuration following withdrawal of first-mentioned leaves as aforesaid.

The pad of the invention may take the form of a notepad with said first-mentioned leaves formed by sheets of note-paper.

A notepad in accordance with the present invention will now be described, by way of example, with reference to the accompanying drawings, in which:

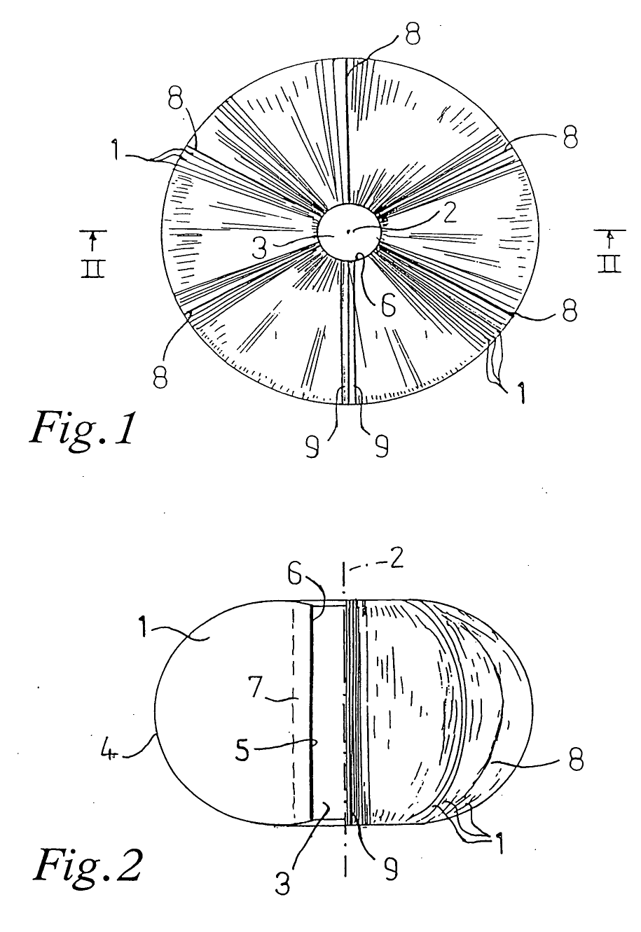

FIG. 1 is a plan view of the notepad of the invention;

FIG. 2 is a part-sectional side-elevation of the notepad, the section of FIG. 2 being taken on the line II-II of FIG. 1;

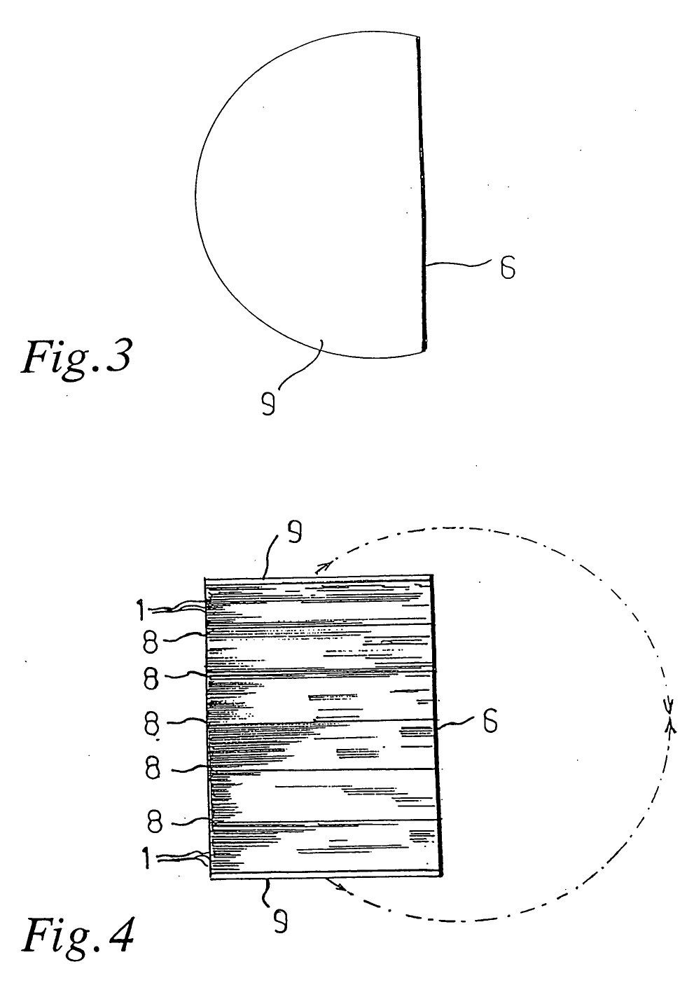

FIGS. 3 and 4 are, respectively, a plan and side-elevation of the notepad of the invention prior to its erection to the configuration illustrated in FIGS. 1 and 2; and

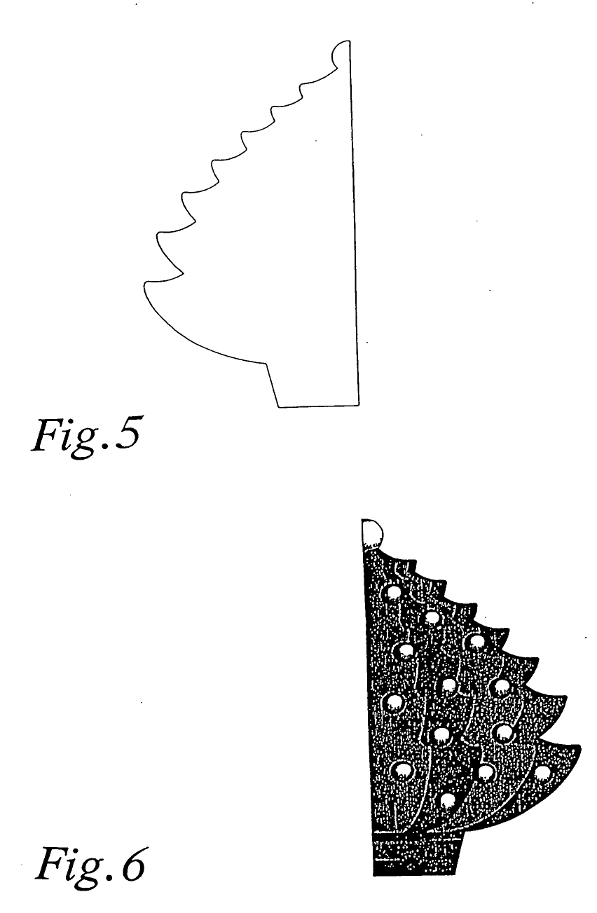

FIGS. 4 and 5 are illustrative of a possible format for decoratively-shaped note-paper sheets of a notepad according to the invention, FIG. 4 showing the obverse, blank area for writing, and FIG. 5 the reverse, decorated area.

Referring to FIGS. 1 and 2, the notepad has a generally spheroidal configuration being assembled from some 350 sheets or leaves 1 of note-paper in a face-to-face relationship fanning out from one another radially about an upright axis 2 of a hollow, cylindrical core 3. The leaves 1, as shown by the section of FIG. 2, have the form of a major segment of a circle defined within curved and straight edges 4 and 5 respectively, and are adhered together at their straight edges 5 along the core 3. More especially, the core 3 is defined by a plastics binding-strip 6 to which the edges 5 of the leaves 1 adhere releasably. In this respect, any leaf 1 can be released from the core 3 for note-use simply by pulling it outwardly from the strip 6 for withdrawal from between the two leaves 1 either side of it. Each leaf 1 has a strip 7 of pressure-sensitive adhesive along the margin of its edge 5 so as to enable it, once withdrawn from the notepad, to be attached elsewhere.

Five sheet-elements 8 of card or other material stiffer than the paper of the leaves 1, together with a pair of thicker card-elements 9, are interleaved with the leaves 1 at regular intervals round the notepad. The elements 8 and 9, which are of the same shape as the leaves 1 and are tightly secured to the binding-strip 6 so that they cannot be pulled free, ensure that the notepad does not collapse but retains its general configuration with the axis 2 upright when leaves 1 are withdrawn.

The notepad is erected from an initial form as illustrated in FIGS. 3 and 4 in which the leaves 1 are assembled in register and face to face upon one another in a vertical stack. The two card-elements 9 form the top and bottom of the stack, and the elements 8 are located intermediate successive blocks of 50 leaves 1, with the whole bound together into the stack by the binding-strip 6.

The strip 6 is flexible enabling the two card-elements 9 to be pulled round (as indicated by the dashed arcs in FIG. 4) to abut one another face to face. This erects the notepad into its spheroidal form with the leaves 1 and elements 8 fanned out from one another around the central core 3 formed by the bent strip 6. The notepad is retained in this form by retention of the elements 9 in firm abutment with one another. This may be by bonding the elements 9 together using adhesive areas that are carried by one or both of them and are revealed when cover strips are peeled from the adhesive areas prior to bringing the elements 9 together.

The hollow, central core 3 may be used to retain a pencil or pen with the notepad, and the notepad may be scented. More especially in the latter respect, the scenting may be located in or on the elements 8 and/or elements 9.

The notepad leaves 1, in particular the edges 4, may be of any shape and may have printing on obverse and/or reverse surfaces. The printing on at least one of the surfaces may be related to the shape of the edge 4 of the leaf 1. For example, the shape of the edge 4 may outline half the face of a person or animal, or half a fruit, a tree or any other object, with printing on the reverse (at least) giving an appropriate pictorial representation related to the shape.

The obverse and reverse of a typical note-paper leaf having the half-shape of a Christmas tree are illustrated by FIGS. 5 and 6 respectively. The obverse in this example is blank for note-writing, whereas the reverse has the decorative printing. The notepad when erected takes up the configuration of a solid of revolution of the relevant shape which, in this case, gives the erected notepad the general three-dimensional appearance of a Christmas tree.

The form of pad according to the invention lends itself to the provision of a novel form of greetings ‘card’ in which the withdrawable leaves have pictorial significance, whether in common or individually, in relation to the intended recipient(s) and/or the greeting to be conveyed. In this regard, the leaves need not make any provision for note-writing, but may have pictorial or other printing on both obverse and reverse, and may be for selection for withdrawal randomly, or in turn according to some indicated sequence.

The leaves may in the more general context provide a resource, for example for amusement, education, comfort or encouragement, the user withdrawing one when desired, or periodically; for example there may be 365 or 366 leaves to provide for one to be withdrawn day by day throughout the year. A child might be assisted to learn, say, the alphabet, the meaning of words, or arithmetic (for example, multiplication tables) by use of a pad in which the different leaves contain visual assistance with memorising the relevant aspects of the topic concerned. More specifically, for example, the pad may take the form of an Advent Calendar in which the leaves have significance for the days of Advent and are for withdrawal one by one as each day passes. In this specific case and where a greetings ‘card’ is involved there would normally be significantly fewer withdrawable leaves than in the notepad described above.

1-14. (CANCELED).

15. A pad assembly comprising a plurality of first leaves, a plurality of second leaves that are stiffer than the first leaves, the second leaves being interspersed face to face with the first leaves in the assembly, and restraining means for restraining the assembly in a configuration in which the first and second leaves fan out from one another about a common axis, the first leaves being selectively withdrawable individually from between the second leaves in the assembly, and wherein the restraining means restrains the second leaves from withdrawal individually from the assembly so that the second leaves maintain support of the assembly in said configuration following withdrawal of the first leaves from the assembly as aforesaid.

16. A pad in which a multiplicity of leaves are assembled together face to face with one another in a stack having a top and a bottom, the stack comprising first leaves, second leaves located at mutually-spaced intermediate locations within the stack, the second leaves being stiffer than the first leaves, top and bottom leaves located at the top and bottom respectively of the stack, and a bendable binding to the stack for enabling the stack to be bent round into a configuration in which the top and bottom leaves are in face-to-face contact with one another with the first leaves fanning out from one another about a common axis, the first leaves being individually releasable from the pad by selective withdrawal from between adjacent leaves of the stack, and wherein there are a plurality of the second leaves located respectively at the mutually-spaced locations for maintaining support of the stack in said configuration following withdrawal of the first leaves as aforesaid.

17. The pad according to claim 16 wherein at least one of the top and bottom leaves includes adhesive for bonding the top and bottom leaves together when they are brought into face-to-face contact with one another.

18. The pad according to claim 16 wherein said configuration is substantially that of a spheroid.

19. The pad according to claim 16 wherein the first leaves are all of the same shape as one another, and the first leaves are assembled in register with one another in the stack.

20. The pad according to claim 16 wherein each of the first leaves includes a strip of pressure-sensitive adhesive by which the respective leaf is releasably retained in the stack.

21. The pad according to claim 16 wherein each of the first leaves carries printing.

22. The pad according to claim 16 wherein the second leaves are of card.

23. A notepad wherein a multiplicity of sheets of note-paper are assembled together face to face with one another and with a plurality of intermediate sheets that are stiffer than the note-paper sheets in a configuration in which the note-paper and intermediate sheets fan out from one another substantially radially from a common axis, the note-paper sheets being individually releasable from the notepad by withdrawal from between their adjacent sheets, and wherein the intermediate sheets are distributed through the notepad for maintaining support for the pad in said configuration following withdrawal of note-paper sheets as aforesaid.

24. A notepad comprising a multiplicity of sheets of note-paper assembled together face to face with one another into a stack that includes top, bottom and intermediate sheets that are stiffer than the note-paper sheets, the stack having a bendable binding along one of its edges to enable the top and bottom sheets to be brought round face to face with one another into a configuration of the stack in which the note-paper sheets fan out from one another substantially radially from a common axis and are individually releasable from the notepad by withdrawal from between their adjacent sheets, and wherein there are a plurality of said intermediate sheets distributed through the notepad for maintaining support for the pad in said configuration following withdrawal of note-paper sheets as aforesaid.

25. The notepad according to claim 24 wherein the configuration of the stack is substantially that of a spheroid.

26. The notepad according to claim 24 wherein the note-paper sheets are all of the same shape as one another, and the note-paper sheets are in register with one another in the stack.

27. The notepad according to claim 24 wherein each note-paper sheet includes a strip of pressure-sensitive adhesive for releasably retaining the note-paper sheet in the stack.

28. The notepad according to claim 24 wherein each of the note-paper sheets has printing on at least one side.
